(19) United States
(12) Patent Application Publication
(10) Pub. No.: US 2023/0292769 A1
(43) Pub. Date: Sep. 21, 2023

(54) DEVICE FOR SPREADING DOUGHS

(71) Applicant: MINIPAN S.R.L., MASSA LOMBARDA (IT)

(72) Inventors: Davide LEONI, CONSELICE (IT); Alessandro LANDI, BAGNACAVALLO (IT)

(21) Appl. No.: 18/185,009

(22) Filed: Mar. 16, 2023

(30) Foreign Application Priority Data
Mar. 17, 2022 (IT) 102022000005201

(51) Int. Cl. A21C 3/02

(52) U.S. Cl. CPC A21C 3/02

(57) ABSTRACT

A device for spreading doughs includes at least one supporting surface on which a predefined quantity of dough can be accommodated, and movement elements for a frame which accommodates sliding blocks which protrude toward the supporting surface. The movement elements are configured for at least one displacement of the frame from a first configuration of maximum distance of the blocks from the surface to a second configuration of minimum distance. The blocks are controlled by a respective actuator configured for their translation according to a predefined stroke on their plane of arrangement. When the frame is in the second configuration, the translation of the blocks occurs from a first arrangement, in which they are mutually close, to a second arrangement, in which they are mutually spaced, producing the transverse stretching of the predefined quantity of dough with consequent widening thereof and reduction of its thickness.

### CROSS-REFERENCE TO RELATED APPLICATIONS

This application claims the benefit of Italian patent application 102022000005201, filed on 17 Mar. 2022, the disclosure of which is incorporated herein by reference in its entirety.

### TECHNICAL FIELD

The present disclosure relates to a device for spreading doughs.

The term “spreading” is to be understood as the operation (generally performed manually by an operator) by means of which the dough undergoes a transverse stretching, i.e. a widening (understood as an increase in the dimension of its contour), with a consequent thinning thereof (due to the phenomenon of necking).

### BACKGROUND

This operation is generally performed on focaccias, pinsas, spianatas, pizzas, flatbreads, baked products with a substantially laminar shape and other similar food products, in order to give the right thickness and dimension to the dough before baking it.

As these are generally highly hydrated doughs (i.e., doughs in which the water content is more than 55% by weight on the flour content), it is always preferable to resort to manual spreading by an operator to avoid tearing the dough.

Industrial rolling units of the known type instead can operate easily only on doughs that are not very hydrated (percentage by weight of water with respect to the flour lower than 50%) and in any case allow to provide products that are very different (in terms of appearance and organoleptic properties) from handcrafted products. For this reason, the use of industrial rolling units is not widespread and is relegated to products with lower quality standards with respect to handcrafted ones.

### SUMMARY

The aim of the present disclosure is to solve the problems described above by providing a device for spreading doughs which allows the automated forming of focaccias, pinsas, spianatas, pizzas, flatbreads, baked products with a substantially laminar shape and other similar food products with characteristics that are similar to handcrafted ones.

Within this aim, the disclosure provides a device for spreading doughs that can operate on high-hydration doughs.

the disclosure also provides a device for spreading doughs which is suitable for imprinting on the dough, after its spreading, impressions similar to those left by the fingers of a manual operator.

the disclosure further provides a device for spreading doughs with to high productivity.

The disclosure provides a device for spreading doughs that is structurally simple.

the disclosure also provides a device for spreading doughs constituted by materials that are suitable for the food industry and can be washed and is sanitized easily.

The present disclosure also provides a device for spreading doughs that has low costs, is relatively simple to provide in practice and of safe application.

This aim and these and other advantages that will become more apparent hereinafter are achieved by providing a device for spreading doughs of the type comprising at least one supporting surface on which a predefined quantity of dough can be accommodated, characterized in that it comprises movement means for a frame which accommodates a plurality of sliding blocks which protrude toward said supporting surface, said movement means being configured for at least one displacement of said frame from a first configuration of maximum distance of said blocks from said surface to a second configuration of minimum distance of said blocks from said surface, said sliding blocks being controlled by a respective actuator configured for their translation according to a predefined stroke on their plane of arrangement, when said frame is in said second configuration the translation of said blocks from a first arrangement, in which they are mutually close, to a second arrangement, in which they are mutually spaced, producing the transverse stretching of said predefined quantity of dough with consequent widening thereof and reduction of its thickness.

### BRIEF DESCRIPTION OF THE DRAWINGS

Further characteristics and advantages of the disclosure will become better apparent from the description of a preferred but not exclusive embodiment of the device for spreading doughs, illustrated by way of non-limiting example in the accompanying drawings, wherein:

FIG. 1 is a schematic axonometric top view of a possible embodiment of a device for spreading doughs according to the disclosure;

FIG. 2 is a schematic axonometric bottom view of the device of FIG. 1;

FIG. 3 is a schematic axonometric view of a first step of operation of the device of FIG. 1;

FIG. 4 is a schematic axonometric view of a second step of operation of the device of FIG. 1;

FIG. 5 is a schematic top view of the second step of operation of the device of FIG. 1; and

FIG. 6 is a schematic top view of a third step of operation of the device of FIG. 1.

### DETAILED DESCRIPTION OF THE DRAWINGS

With particular reference to the figures, a device for spreading doughs is generally designated by the reference numeral 1.

The device 1 for spreading doughs A comprises at least one supporting surface 2 on which a predefined amount of dough A can be accommodated.

The device 1 advantageously comprises movement means for a frame 3 which accommodates a plurality of sliding blocks 4 which protrude towards the supporting surface 2.

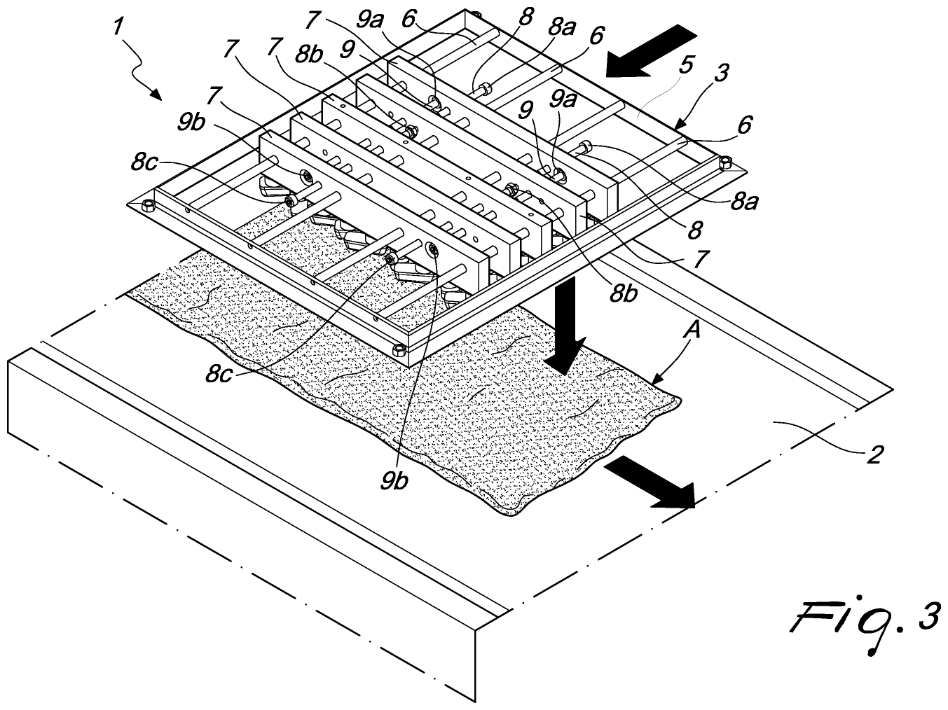

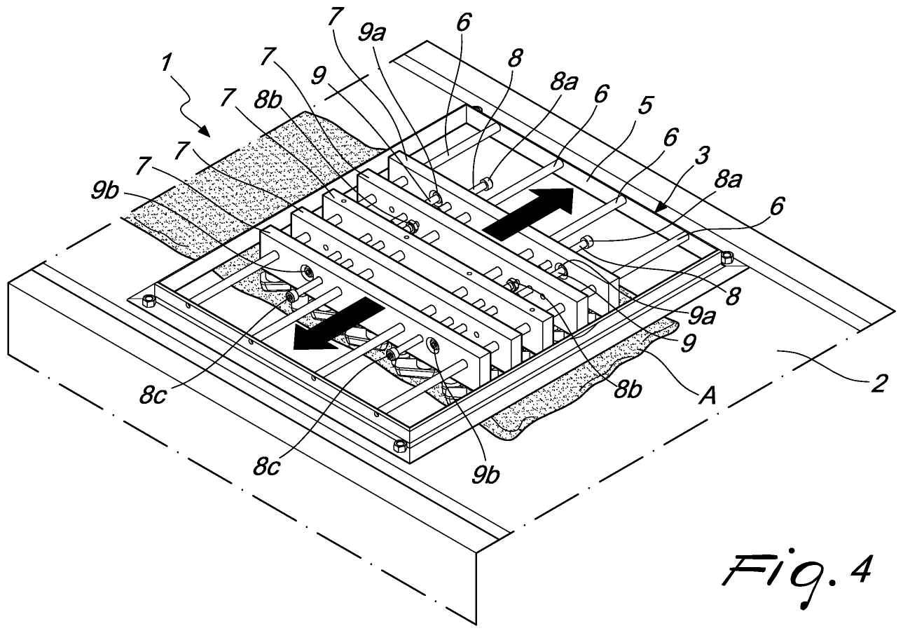

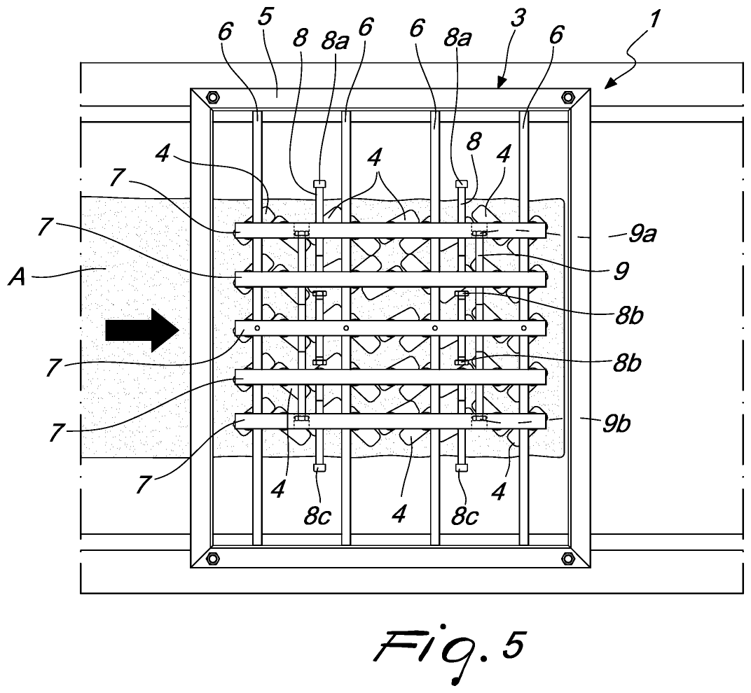

The movement means are configured to generate at least one displacement of the frame 3 from a first configuration of maximum distance of said sliding blocks 4 from the surface 2 (illustrated by way of non-limiting example in the accompanying FIG. 3) to a second configuration of minimum distance of said sliding blocks 4 from the surface 2 (illustrated by way of non-limiting example in the accompanying FIGS. 4, 5 and 6).

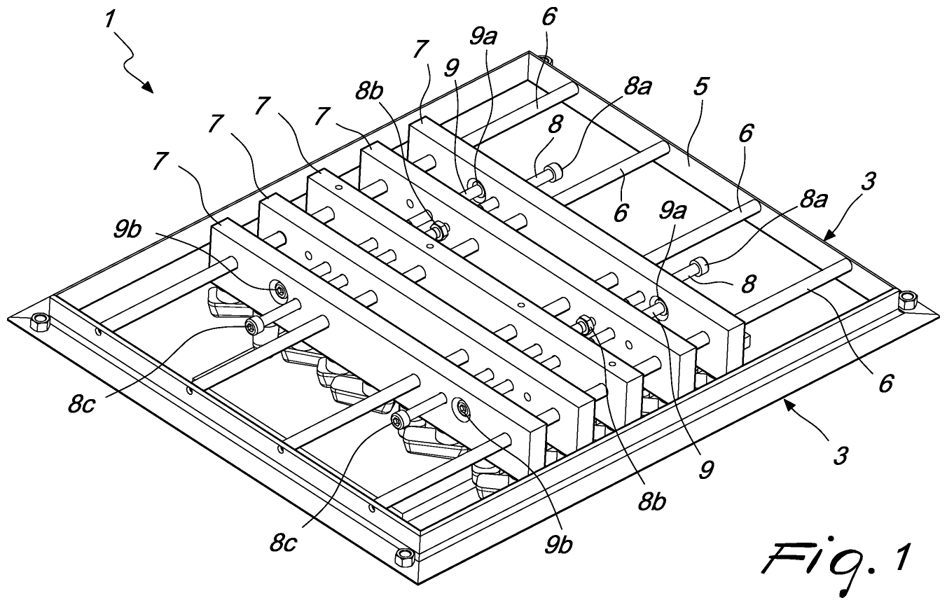

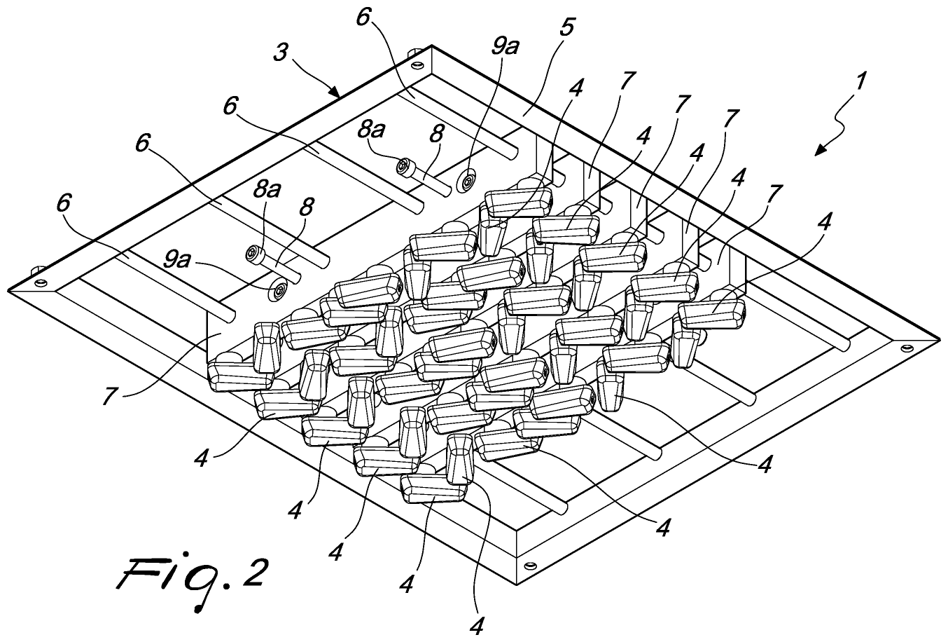

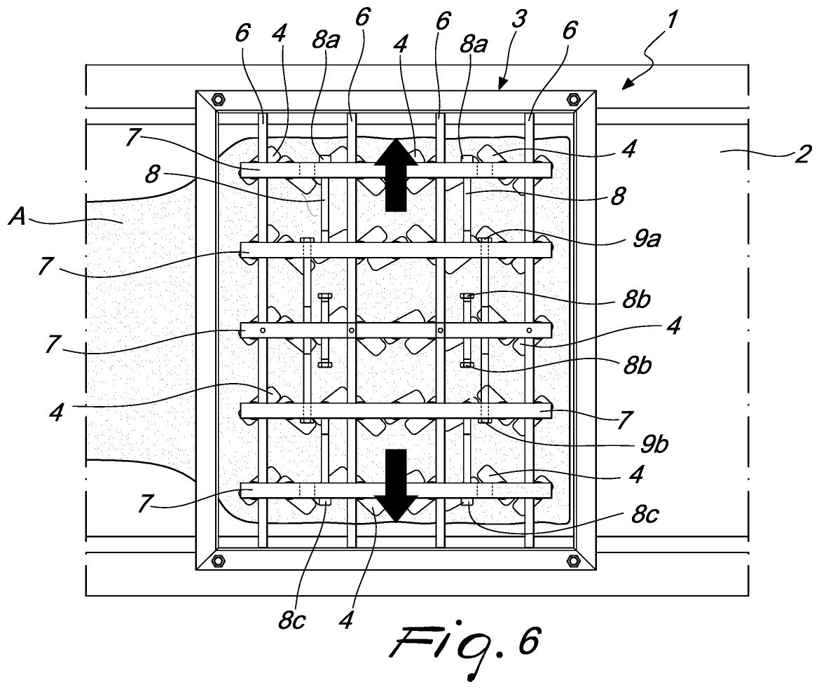

The sliding blocks 4 are conveniently served by a respective actuator configured for their translation along a predefined stroke on their plane of arrangement. When the frame 3 is in the second configuration (i.e., arranging the blocks 4 at the minimum distance from the surface 2), the translation of the blocks 4 (by the respective actuator) occurs from a first arrangement, in which they are mutually close (illustrated by way of non-limiting example in the accompanying FIGS. 1, 2, 3, 4 and 5), to a second arrangement, in which they are mutually spaced (illustrated by way of non-limiting example in the accompanying FIG. 6), causing the transverse stretching of the predefined amount of dough A, with consequent widening thereof and reduction of its thickness.

With particular reference to an embodiment of unquestionable interest in practice and in application, the frame 3 may advantageously comprise a perimetric border 5 which supports a plurality of transversely distributed parallel crossmembers 6, with respect to which the blocks 4 can slide.

In greater detail, the frame 3 favorably comprises a plurality of bands 7 which are perpendicular to the crossmembers 6 and are slidingly engaged thereon.

Each band 7 is intended to support at least one block 4.

The sliding of the bands 7 on the crossmembers 5 causes the mutual displacement of the blocks 4 from the first arrangement (in which they are mutually close) to the second arrangement (in which they are mutually further apart).

It should be specified that advantageously the at least one actuator configured to produce the translation of the blocks 4 is specifically configured to move mutually apart the outermost perpendicular bands 7.

In general terms, it should be noted that the blocks 4 arranged at the centerline of the frame 3 are positively fixed.

Sliding connecting elements 8, 9 are installed between the other blocks 4 (arranged externally with respect to those located at the centerline of the frame 3) and are provided with shoulders (respectively, the shoulders 8a, 8b and 8c on the connecting element 8 and the shoulders 9a and 9b on the shoulder element 9) designed to constitute stroke limits for the mutual entrainment of the blocks 4.

In particular, by applying traction only to the outermost blocks 4, these, by virtue of the connecting elements, also entrain the other innermost blocks 4 until a position of maximum mutual spacing is reached which corresponds to the second arrangement of said blocks 4.

With particular reference to the embodiment shown in the accompanying figures, the central band 7 is usefully fixed and sliding connecting rods (constituting a possible embodiment of the connecting is elements 8 and 9) are efficiently arranged between the other bands 7 that are external to the central one (which are mutually contiguous) and are provided with stroke limit shoulders (8a, 8b and 8c and 9a and 9b, respectively) for the mutual entrainment of the bands 7.

In particular, it can be easily understood by observing the accompanying figures that by applying traction only to the outermost bands 7 said bands also entrain the ones interposed between them and the fixed central band 7 (by virtue of the presence of the sliding connecting rods 8 and 9 provided with the respective stroke limit shoulders 8a, 8b, 8c, 9a, 9b) until a position of maximum mutual spacing of said bands 7 is reached (illustrated by way of non-limiting example in the accompanying FIG. 6) which corresponds to the second arrangement of the blocks 4.

It is necessary to point out that each block 4 may advantageously have a shape chosen from a polyhedron with rounded edges, a cylinder, a frustum, at least one portion of a sphere, a barrel, a solid having a base that resembles a predefined contour, and the like. On the frame 3, each block 4 may have any orientation, on the common plane of arrangement, with respect to the others that are present in said frame.

The specific shape and orientation, which can optionally be random, of the blocks 4 on frame 3 is intended to produce an action on the dough A that is as similar as possible to the action that would be exerted by the fingers of a manual worker who wishes to spread the dough by stretching it transversally.

The shape of the blocks 4, therefore, can conveniently resemble that of phalanges of human fingers, so that the impressions left in the dough A spread and stretched by the blocks 4 are as similar as possible to the impressions that can be observed on a dough flattened by hand (i.e., by an operator with his hands).

It is specified that the movement means that are associated with the frame 3 to install it in a food production plant are usefully of a type chosen from a Cartesian mover, a robotic arm and the like.

The at least one supporting surface 2, in this case, is advantageously is of the type of a conveyor belt for conveying the predefined quantity of dough A from a doughing station, arranged upstream, to a station for processing the spread dough A (e.g. for its filling, freezing, baking, and the like).

It is specified that in such a case the movement means associated with the frame 3 are validly of the type configured to maintain the second configuration of the frame 3, following the conveyor belt that constitutes the surface 2, for a predefined time necessary for the movement of the blocks 4 from the first arrangement (in which they are mutually closer) to the second arrangement (in which they are separated and therefore have stretched the dough A transversely, spreading it).

It is specified that since the food dough A remains constantly resting on the surface 2, it does not need to have a high consistency and tensile strength (characteristics which would be necessary if the dough A were to be suspended temporarily), and therefore it is specified that the device 1 according to the disclosure is particularly suitable for operating on doughs with high hydration (i.e., in which the percentage by weight of water with respect to the flour is greater than 55%). This is particularly useful since at present it is only possible to operate in a manual (artisanal) manner on high-hydration doughs A.

Advantageously, the present disclosure solves the above mentioned problems by providing a device 1 for spreading doughs A that allows the automated forming of focaccias, pinsas, spianatas, pizzas, flatbreads, baked goods having a substantially laminar shape and other similar food products with characteristics that are similar to those of handcrafted ones.

Conveniently, the device 1 according to the disclosure can operate on high hydration doughs.

Favorably, the device 1 according to the disclosure is suitable to imprint impressions in the dough, after it has been spread, which are similar to those left by the fingers of a manual worker.

Positively, the device 1 according to the disclosure has high productivity.

Usefully, the device 1 according to the disclosure is structurally simple.

Advantageously, the device 1 according to the disclosure is constituted by materials which are suitable for the food industry and can be washed and sanitized easily.

Validly, the device 1 according to the disclosure is relatively simple to provide in practice and low in cost: these characteristics make the device 1 according to the disclosure an innovation of assured application.

The disclosure thus conceived is susceptible of numerous modifications and variations, all of which are within the scope of the appended claims; all the details may furthermore be replaced with other technically equivalent elements.

In the illustrated exemplary embodiments, individual characteristics, shown in relation to specific examples, may in fact be interchanged with other different characteristics that exist in other exemplary embodiments.

In practice, the materials used, as well as the dimensions, may be any according to the requirements and the state of the art.

1. A device for spreading dough comprising at least one supporting surface on which a predefined quantity of dough is accommodated, and further comprising movement means for a frame which accommodates a plurality of sliding blocks which protrude toward said supporting surface, said movement means being configured for at least one displacement of said frame from a first configuration of maximum distance of said sliding blocks from said surface to a second configuration of minimum distance of said sliding blocks from said surface, said sliding blocks being controlled by a respective actuator configured for the translation of said sliding blocks according to a predefined stroke on a plane of arrangement of said sliding blocks, when said frame is in said second configuration the translation of said sliding blocks from a first arrangement, in which the sliding blocks are mutually close, to a second arrangement, in which the sliding blocks are mutually spaced, producing a transverse stretching of said predefined quantity of dough with consequent widening thereof and reduction of thickness of the dough.

2. The device according to claim 1, wherein said frame comprises a perimetric border which supports a plurality of transversely distributed parallel crossmembers, with respect to which said sliding blocks are configured to slide.

3. The device according to claim 2, further comprising a plurality of bands which are perpendicular to said crossmembers and are engaged slidingly thereon, each band being designed to support at least one sliding block, the sliding of said bands on said transversely distributed parallel crossmembers producing a mutual displacement of said sliding blocks from said first arrangement to said second arrangement.

4. The device according to claim 3, wherein said at least one actuator configured for the translation of said sliding blocks is configured for a mutual spacing of said outermost perpendicular bands.

5. The device according to claim 3, wherein the sliding blocks arranged at a centerline of said frame are fixed, sliding connecting elements being arranged between the other sliding blocks that are external to the ones arranged at the centerline of said frame and being provided with stroke limit shoulders for the mutual entrainment of said blocks by applying a traction only to the outermost ones, until a maximum mutual spacing position is reached which corresponds to said second arrangement of said blocks.

6. The device according to claim 4, wherein said central band is fixed and sliding connecting rods are arranged between contiguous other bands which are external to the central band, and are provided with stroke limit shoulders for a mutual entrainment of said bands by applying a traction only to the outermost bands, until a position of maximum mutual spacing is reached which corresponds to said second arrangement of said sliding blocks.

7. The device according to claim 1, wherein each said sliding block has a shape chosen from a polyhedron with rounded edges, a cylinder, a frustum, at least one portion of a sphere, a barrel, a solid which has a base that resembles a predefined contour, each sliding block having any orientation, on a common plane of arrangement, with respect to other sliding blocks that are present in said frame.

8. The device according to claim 1, wherein said movement means for said frame are chosen from a Cartesian mover, a robotic arm, and the like.

9. The device according to claim 1, wherein said at least one supporting surface is a conveyor belt for conveyance of said predefined quantity of dough from a doughing station, arranged upstream, to a station for treating said spread dough.

10. The device according to claim 9, wherein said movement means for said frame are configured to maintain said second configuration of said frame, following said conveyor belt, for a predefined time that is necessary for the displacement of said sliding blocks from said first arrangement to said second arrangement.
